(19) United States
(12) Patent Application Publication
(10) Pub. No.: US 2016/0192016 A1
(43) Pub. Date: Jun. 30, 2016

(54) METHODS AND SYSTEMS FOR IDENTIFYING MEDIA ASSETS

(71) Applicant: Rovi Guides, Inc., Santa Clara, CA (US)

(72) Inventors: Brian Peterson, Barrington, IL (US); Phil Golyshko, Pacifica, CA (US)

(73) Assignee: ROVI GUIDES, INC., Santa Clara, CA (US)

(21) Appl. No.: 14/582,887

(22) Filed: Dec. 24, 2014

(51) Int. Cl. H04N 21/472; H04N 21/482; H04N 21/44; H04N 21/442; H04N 21/431

(52) U.S. Cl. CPC H04N 21/47214; H04N 21/44204; H04N 21/4316; H04N 21/4318; H04N 21/44008; H04N 21/482

(57) ABSTRACT

Methods and systems are disclosed herein for a media guidance application that selects an identifier for a media asset based on an object corresponding to a user's point of progression in the media asset. For example, after determining the user's point of progression in the media asset and identifying an object corresponding to the user's point of progression in the media asset, the media guidance application may cross-reference a database listing objects in media asset identifiers for the media asset, select a media asset identifier from the media asset identifiers that includes the object, and generate for display the selected media asset identifier. The selected media asset identifier may be modified to graphically accentuate the object and enhance its visibility.

### BACKGROUND

In conventional systems, users are able to access a plethora of media assets. In order to identify this plethora of media assets, the media assets are often accompanied by media asset identifiers. Over time, more of these media asset identifiers have become available (e.g., alternate posters, cover art, etc.). However, there is currently no use for these alternatives other than in promotional materials.

### SUMMARY

Accordingly, methods and systems are disclosed herein for a media guidance application that selects an identifier for a media asset. In particular, the media guidance application may automatically select a media asset identifier based on the contents of the media asset at a user's point of progression in the media asset. For example, the media guidance application may determine that a current scene or frame associated with the user's point of progression within a media asset contains an object (e.g., a character). The media guidance application may then select an image (e.g., a poster or cover art related to the media asset) for a media asset identifier based on whether or not the image contains that object. By doing so, the media guidance application may alert the user to the events the user will view upon selecting the media asset, which may entice the user to select the media asset as well as serve as a reminder of previously-viewed events in the media asset.

In some aspects, a media guidance application may determine (e.g., via control circuitry) a user's point of progression in a media asset. For example, the media guidance application may determine a frame or scene that is associated with the user's point of progression. After determining the user's point of progression, the media guidance application may identify (e.g., via control circuitry) an object corresponding to the user's point of progression in the media asset. For example, the media guidance application may access a data structure (e.g., located at storage circuitry) listing objects (e.g., characters in the media asset) present in the current scene or frame.

The media guidance application may then select a media asset identifier that includes the object. For example, the media guidance application may cross-reference (e.g., via control circuitry) a database listing objects in media asset identifiers for the media asset (e.g., located at storage circuitry) to select a media asset identifier that includes the object.

The media guidance application may then generate for display the selected media asset identifier. For example, once the media guidance application selects an appropriate media asset identifier, the media guidance application may cause the media asset identifier to appear on a display screen.

In some embodiments, the media guidance application may retrieve the media asset identifiers for the media asset, determine each of the objects in each of the media asset identifiers, and populate a database with each of the objects. For example, the media guidance application may access a data structure (e.g., located at storage circuitry) to retrieve a list of media asset identifiers, process them (e.g., via control circuitry) in order to determine the objects present therein, and store a listing of the objects for later retrieval.

In some embodiments, the media guidance application may also determine a location of the identified object within the image and graphically accentuate the identified object within the image. For example, the media guidance application may alter (e.g., via control circuitry) an opaqueness level or a brightness level of the object relative to the selected media asset identifier.

In some embodiments, the media guidance application may select a default media asset identifier if the object is not found in the database. For example, if the media guidance application does not find a media asset identifier that contains the identified object in the database of media asset identifiers, the media guidance application may select a predetermined default media asset identifier instead.

In some embodiments, the media guidance application may identify a plurality of objects that correspond to the user's point of progression in the media asset. In such a case, the media guidance application may select (e.g., via control circuitry) one of those objects to be cross-referenced. For example, if the current scene in the media asset contains multiple identified characters, the media guidance application may select one of those characters to be cross-referenced with the database listing objects in media asset identifiers for the media asset.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative example of a media asset identifier selected based on the user's viewing progression in accordance with some embodiments of the disclosure;

FIG. 6 is a flowchart of illustrative steps for selecting a media asset identifier based on a user's playback progression in accordance with some embodiments of the disclosure; and

FIG. 7 is a flowchart of illustrative steps for presenting a modified media asset identifier based on whether or not an object or objects detected in the media asset identifier has been generated for display at the user's point of progression in accordance with some embodiments of the disclosure.

### DETAILED DESCRIPTION OF THE DRAWINGS

Methods and systems are disclosed herein for a media guidance application that selects an identifier for a media asset. In particular, the media guidance application may automatically select a media asset identifier based on the contents of the media asset at a user's point of progression in the media asset. For example, the media guidance application may determine that a current scene or frame associated with the user's point of progression within a media asset contains an object (e.g., a vehicle). The media guidance application may then select an image (e.g., a poster or cover art related to the media asset) for a media asset identifier based on whether or not the image contains that object. By doing so, the media guidance application may alert the user to the events the user will view upon selecting the media asset, which may entice the user to select the media asset as well as serve as a reminder of previously-viewed events in the media asset.

As referred to herein, “a media guidance application,” “interactive media guidance application,” or “guidance application” is an application that allows a user to navigate through and access available media content. The media guidance application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, Random Access Memory (“RAM”), etc.

Media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, a wearable electronic device (e.g., computer glasses, computer watches, computer wristbands, etc.) or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

In some embodiments, a media guidance application may determine (e.g., via control circuitry) a user's point of progression in a media asset. For example, the media guidance application may determine a frame or scene associated with the user's point of progression. The media guidance application may make this determination by finding a frame within a sequence of frames included in the media asset. This frame may correspond to a particular time-mark in the runtime of a media asset or a point at which the user paused playback of the media asset. In another example, the media guidance application may determine a scene associated with a particular time-mark by accessing a metadata structure containing scene information for the media asset.

As referred to herein, a “user's point of progression” is the point last viewed by the user in the media asset. This may be for a media asset that is currently being viewed (e.g., the current elapsed time within the media asset) or for a media asset that has been paused for later viewing (e.g., the point at which the media asset playback was paused). For example, the user's point of progression may correspond to a particular frame, scene, or other segment of a media asset. In another example, the point of progression may correspond to a particular time-mark (e.g., the thirty minute mark) in the runtime of a media asset.

After determining the user's point of progression, the media guidance application may identify (e.g., via control circuitry) an object corresponding to the user's point of progression in the media asset. As referred to herein, an “object” is any content in a media asset that is distinguishable from other content in the media asset. For example, an object may correspond to a specific character, vehicle, piece of text, or other item present in one or more frames of a media asset. In some embodiments, an object may be limited to content that may be consumed by a user accessing the media asset. For example, an object may include content of a media asset that is generated for display to a user on a display screen. In some embodiments, an object may include content that while part of the media asset is not necessarily presented to a user. For example, the content may include metadata that is not generated for display to a user on a display screen or other data (e.g., closed captioning) that is not always (e.g., is subject to user discretion) generated for display to a user on a display screen.

The media guidance application may use numerous techniques for detecting and/or identifying objects. For example, the media guidance application (e.g., via control circuitry) may access or incorporate a detection module. The media guidance application may use the detection module to detect events in media assets. For example, the media guidance application may use a content recognition module or algorithm to generate data describing the objects appearing in one or more portions of a media asset. For example, the content recognition module may use object recognition techniques such as edge detection, pattern recognition, including, but not limited to, self-learning systems (e.g., neural networks), optical character recognition, on-line character recognition (including but not limited to dynamic character recognition, real-time character recognition, intelligent character recognition), and/or any other suitable technique or method to determine objects in the media asset.

For example, the media guidance application may receive data in the form of a video. The video may include a series of frames. For each frame of the video, the media guidance application may use a content recognition module or algorithm to determine the objects (e.g., people, places, things, etc.) in each of the frames or series of frames.

In some embodiments, the content recognition module or algorithm may also include speech recognition techniques, including, but not limited to, Hidden Markov Models, dynamic time warping, and/or neural networks (as described above) to translate spoken words into text and/or processing audio data. The content recognition module may also combine multiple techniques to detect or identify an object. For example, the media guidance application may process audio content (e.g., corresponding to words spoken by a character in a media asset) to determine whether or not an object corresponds to a portion of a media asset.

In addition, the media guidance application may use multiple types of optical character recognition and/or fuzzy logic, for example, when processing keyword(s) retrieved from data (e.g., textual data, translated audio data, user inputs, etc.) describing the media asset (or when cross-referencing various types of data in databases). For example, the media guidance application may detect or identify an object (e.g., metadata) associated with a media asset. The data may be received from a remote source (e.g., media guidance data source 418 (FIG. 4)). In another example, the media guidance application may detect or identify an object (e.g., metadata) associated with a portion of a media asset based on subtitles, closed captioning data, etc. associated with a portion of a media asset. The media guidance application may process this textual data to determine whether or not an object corresponds to a portion of a media asset. If the particular data received is textual data, using fuzzy logic, the media guidance application (e.g., via a content recognition module or algorithm incorporated into, or accessible by, the media guidance application) may determine two fields and/or values to be identical even though the substance of the data or value (e.g., two different spellings) is not identical.

The media guidance application may select a media asset identifier that includes the object. As referred to herein, a “media asset identifier” is content associated with the media asset that identifies the media asset to a user. For example, a media asset identifier may include, but is not limited to, media listings featuring text (e.g., a title) of a media asset. In another example, a media identifier may include, but is not limited to, a mosaic cell featuring an image (e.g., box art, cover art, posters, advertising materials, and/or other graphics related to the media asset) of the media asset.

In some embodiments, the media guidance application may retrieve the media asset identifiers for the media asset, determine each of the objects in each of the media asset identifiers, and populate a database with each of the objects. For example, the media guidance application may access a data structure (e.g., located at storage circuitry) to retrieve a list of media asset identifiers, process them (e.g., via control circuitry) in order to determine the objects present therein, and store a listing of the objects for later retrieval. For example, a single media asset may be associated with multiple images. For example, the images may have been created for advertising or promotional purposes. Furthermore, each image may appear at various times as a media asset identifier (e.g., accompanying a media listing and/or in a mosaic cell associated with the media asset).

In some embodiments, the media guidance application may also determine a location of the identified object within the image and graphically accentuate the identified object within the image. For example, the media guidance application may parse an image to determine coordinates for each object in a media asset. The media guidance application may then use the coordinates to determine one or more portions of the media asset that should be graphically accentuated.

As referred to herein, “graphically accentuating” is any modification of an object (or portion of a media asset identifier) relative to other objects (or other portions of a media asset identifier) in a media asset identifier. For example, the media guidance application may graphically accentuate an object may altering the color, brightness, transparency, animation, hue, opaqueness, thickness, or any other feature that affects how an object (or a portion of a media asset identifier) is presented to a user. For example, the media guidance application may graphically accentuate an object by inverting, outlining, highlighting, bolding, etc. the object relative to other objects in the media asset identifier.

In some embodiments, the media guidance application may select a default media asset identifier if the object is not found in the database. For example, if the media guidance application does not find a media asset identifier that contains the identified object in the database of media asset identifiers, the media guidance application may select at random a media asset identifier from among a list of available media asset identifiers instead. In some embodiments, the selection of the default media asset identifier may be static. That is, the media guidance application may select the same media asset identifier any time the object is not found in the database. Alternatively, the selection of the default media asset identifier may be dynamic. That is, the media guidance application may select a different media asset identifier any time the object is not found in the database. The media guidance application may use any criteria for this selection. For example, the media asset identifiers may be selected in alphabetical order by file name (if applicable) or using a pseudo-random number chosen by the media guidance application.

In some embodiments, the media guidance application may identify a plurality of objects that correspond to the user's point of progression in the media asset. In such a case, the media guidance application may select (e.g., via control circuitry) one of those objects to be cross-referenced. For example, if the current scene in the media asset contains multiple identified characters, vehicles, and text strings, the media guidance application may select one of those characters, vehicles, and text strings to be cross-referenced with the database listing objects in media asset identifiers for the media asset. The object may be selected based on various factors, including but not limited to the size or visibility of the object at the user's point of progression (as determined, for example, by brightness), the importance or popularity of an actor portraying an identified character (as determined, for example, by a web search, a list of other media assets that have featured the, and/or a user profile indicating the popularity of the actor), the number of times the object appears throughout the current scene or the media asset as a whole, or any combination thereof. The media guidance application may also choose which object of the detected objects should be selected or accentuated based on a determination of how many media asset identifiers contain a detected object.

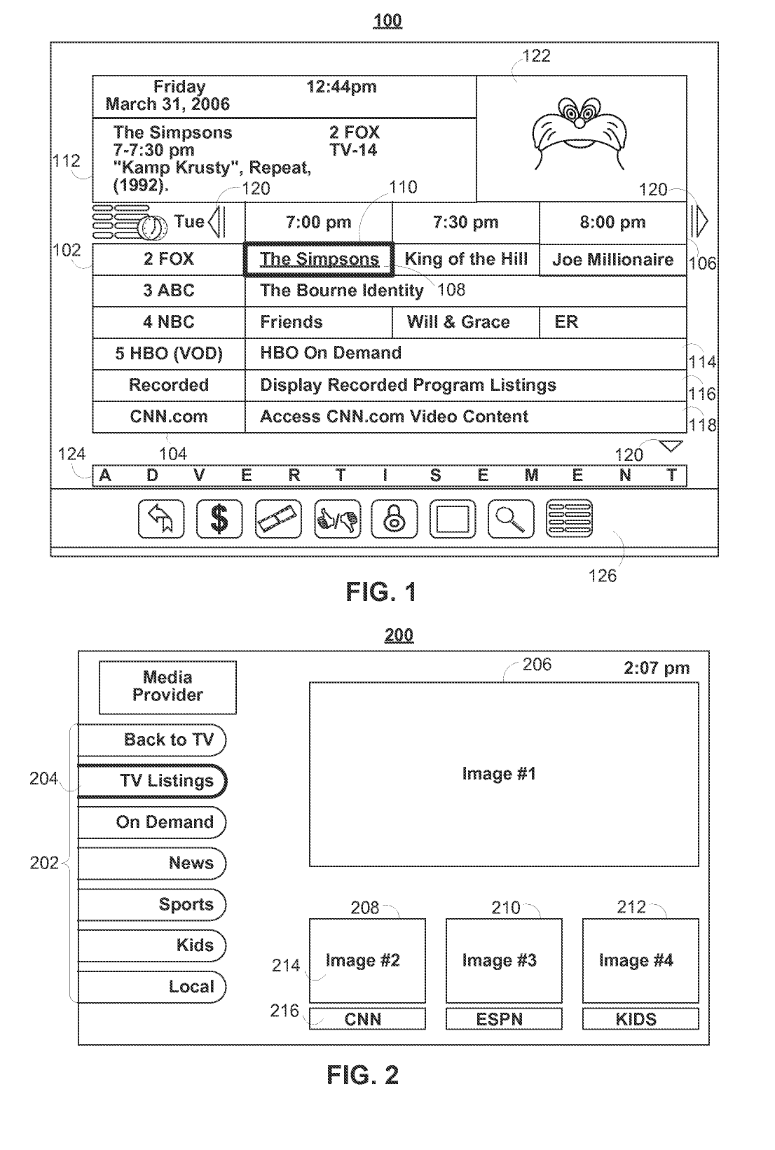

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including media asset identifiers of the type discussed herein (e.g., cover art, still images from the content, etc.), video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

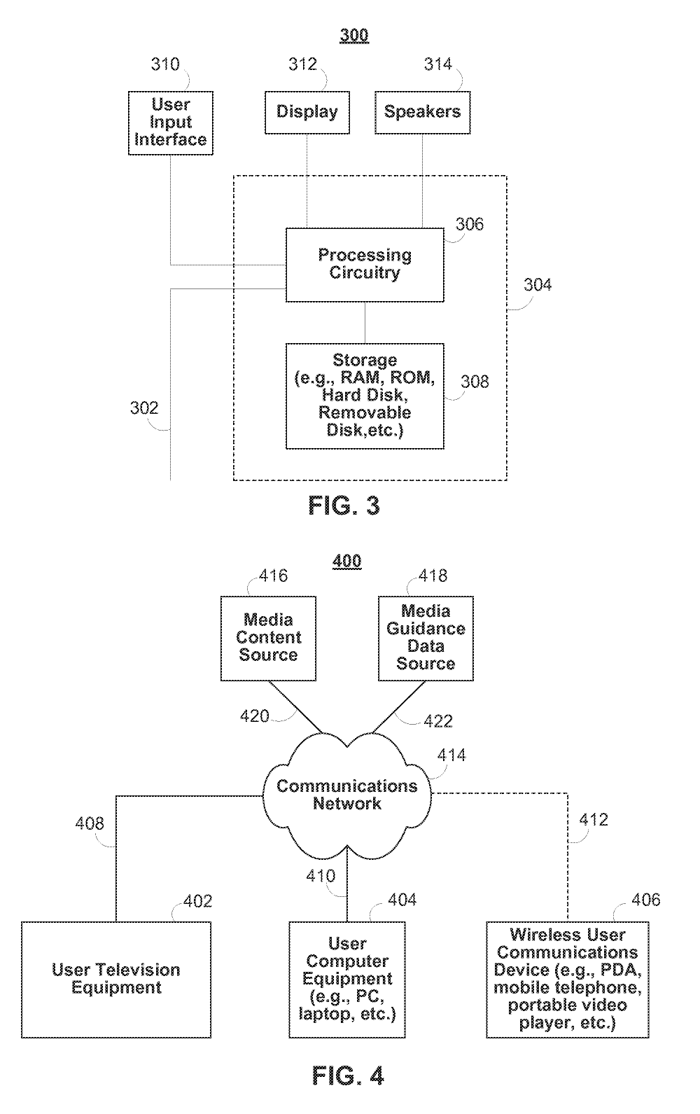

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

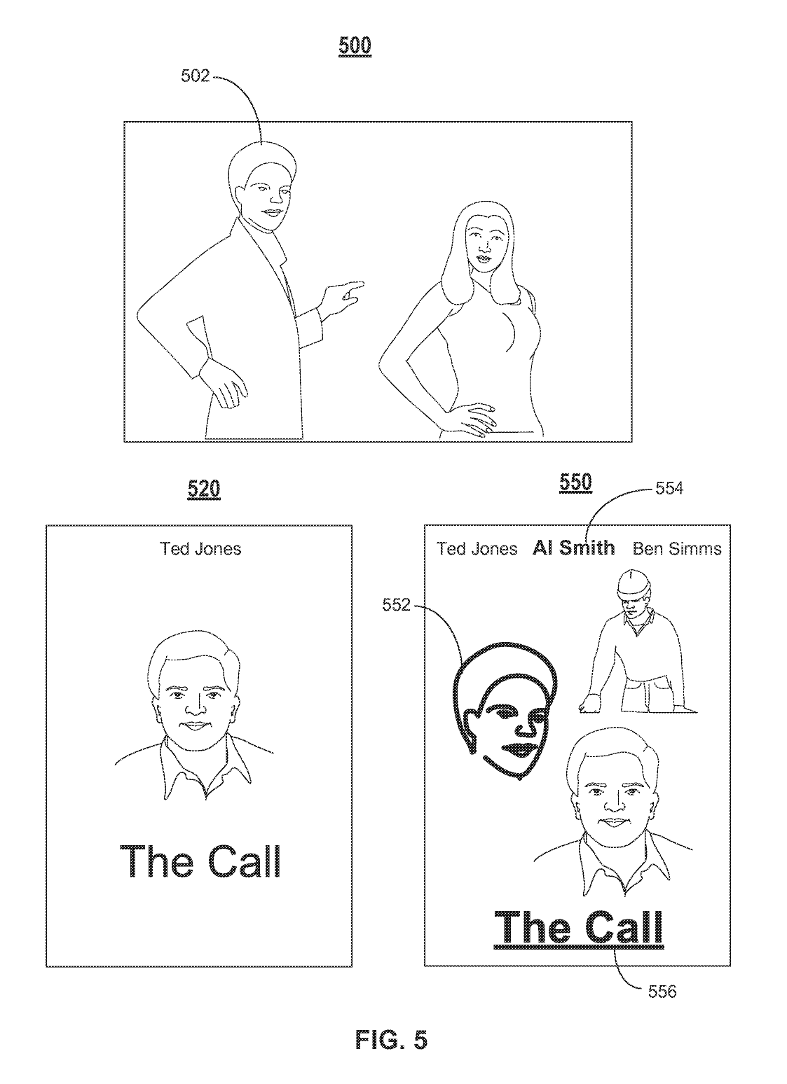

FIG. 5 shows as example of a display screen, for example display 312 of FIG. 3. On the display, frame 500 corresponding to the user's point of progression has been generated (e.g., using control circuitry 304). Object 502, in this case a character, has been identified at the user's point of progression (e.g., by processing circuitry 306). A database, potentially made available to the media guidance application via storage 308 or communications network 414, contains media asset identifiers including first media asset identifier 520 and second media asset identifier 550. The identified object has been cross-referenced against this database.

First media asset identifier 520, which may represent a poster, box art, or another type of media asset identifier, does not contain object 502 and has not been selected for presentation using control circuitry 304. Second media asset identifier 550 does contain object 502 and has thus been selected for presentation. Control circuitry 304 has also determined the location of object 502 as present in second media asset identifier 550 and has graphically accentuated the object, as shown by accentuated object 552, according to some embodiments. For example, the location of object 502 as present in second media asset 550 may be recorded as an array of pixel coordinates defining the outside edge of object 502 as present in second media asset 550. As shown, the line thickness of accentuated object 552 has been modified relative to the second media asset identifier 550. Other components of second media asset identifier 550 relating to object 502 and the media asset have also been accentuated, in particular actor name 554 and media asset title 556. Objects that may not be visible or presented to the user at all times, such as actor name 554 and media asset title 556, may be chosen for graphical accentuation based on information including but not limited to cast listings, credits associated with the media asset, or interactive television program guide information (e.g., from media guidance data source 418).

The type of graphical accentuation used for each type of object and which categories of object to accentuate (e.g., character, vehicle, actor name, title, etc.) may be selected according to user preferences, to maximize the visibility of accentuation relative to the media asset identifier, according to system defaults, or according to any other suitable criteria. An object may be graphically accentuated based on various factors, including but not limited to the size or visibility (as determined, for example, by brightness) of the object in the media asset identifier, the importance or popularity of an actor portraying an identified object (as determined, for example, by a web search or using a list of other media the actor has been in), the number of media asset identifiers containing the object, or any combination thereof.

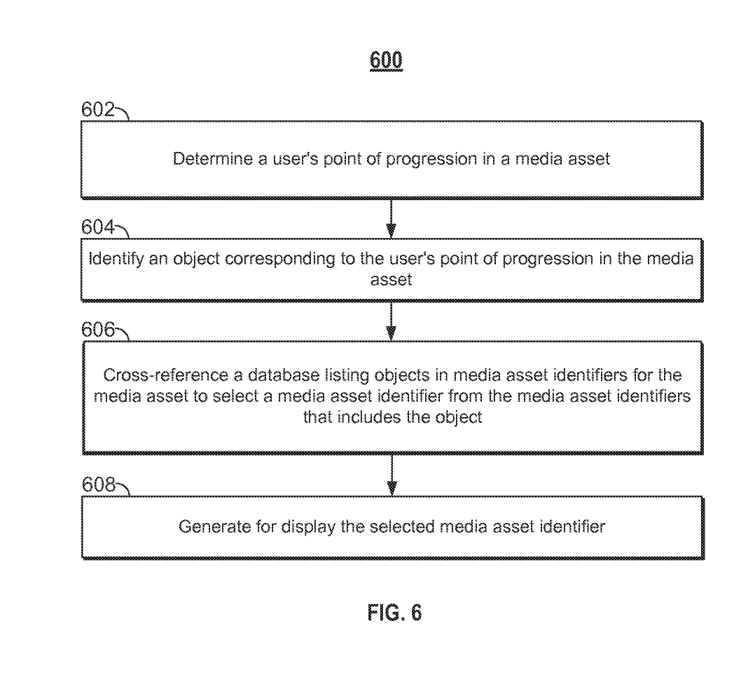

FIG. 6 is a flow chart of illustrative steps for selecting a media asset identifier based on a user's playback progression in accordance with some embodiments of the disclosure. It should be noted that process 600 or any step thereof could be performed on, or provided by, any of the devices shown in FIGS. 3-4. For example, process 600 may be executed by control circuitry 304 (FIG. 3) as instructed by a media guidance application implemented on user equipment 402, 404, and/or 406 (FIG. 4) in order to generate for display clusters based on a ranking. In addition, one or more steps of process 600 may be incorporated into or combined with one or more steps of any other process or embodiment.

At step 602, control circuitry 304 may determine a user's point of progression in a media asset (e.g., an electronically consumable user asset as previously defined), in accordance with some embodiments of the present invention. For example, the user's point of progression may be determined using the frame, such as frame 500 (FIG. 5), or time at which the user paused the media asset. These media assets may be, for example, retrieved from storage 308, media content source 416 using communications network 414, any other suitable content source, or any combination thereof. For example, the media guidance application may receive a user request (e.g., via user input interface 314 (FIG. 3)) for media asset listings, such as previously-viewed media assets or media assets that the user has only partially completed. In response, the media guidance47605500_1 application may determine the user's point of progression in each of the media assets.

At step 604, control circuitry 304 may identify an object corresponding to the user's point of progression in the media asset, in accordance with some embodiments of the present disclosure. For example, a content recognition module or algorithm or optical character recognition algorithm may be used to identify an object present in a frame associated with the user's point of progression. Control circuitry 304 may also process metadata associated with the media content to identify objects present therein. For example, in FIG. 5, object 502 has been identified.

At step 606, control circuitry 304 may cross-reference a database listing objects in media asset identifiers for the media asset to select a media asset identifier from the media asset identifiers that includes the object, in accordance with some embodiments of the present invention. For example, the database may be stored on storage 308, accessed via communications network 414, or accessed using any other suitable communication or data storage system, or any combination thereof. The database may be provided by the provider of media content source 416 or media guidance data source 418 or by a third party. The cross-referencing operation may include searching or filtering the database based on an input of a name, category, or other keyword associated with the object. The output of the search or filter operation may be files containing media asset identifiers, a list of media asset identifiers meeting the specified input criteria, or any other suitable transmittal of media asset identifiers. For example, as discussed above in relation to FIG. 5, control circuitry 304 may not select a first media asset identifier (e.g., first media asset identifier 520 (FIG. 5)) if it does not contain an object (e.g., object 502 (FIG. 5)) present in a media asset at a user's point of progression. However, a second media asset identifier (e.g., second media asset identifier 550 (FIG. 5)) may be selected if it contains the object.

At step 608, control circuitry 304 may generate for display the selected media asset identifier. The generated display may be displayed on display 312 present on user television equipment 402, user computer equipment 404, wireless user communications device 406, or any other type of user equipment suitable for accessing content, such as a non-portable gaming machine. For example, second media asset identifier 550 is shown as generated for display.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

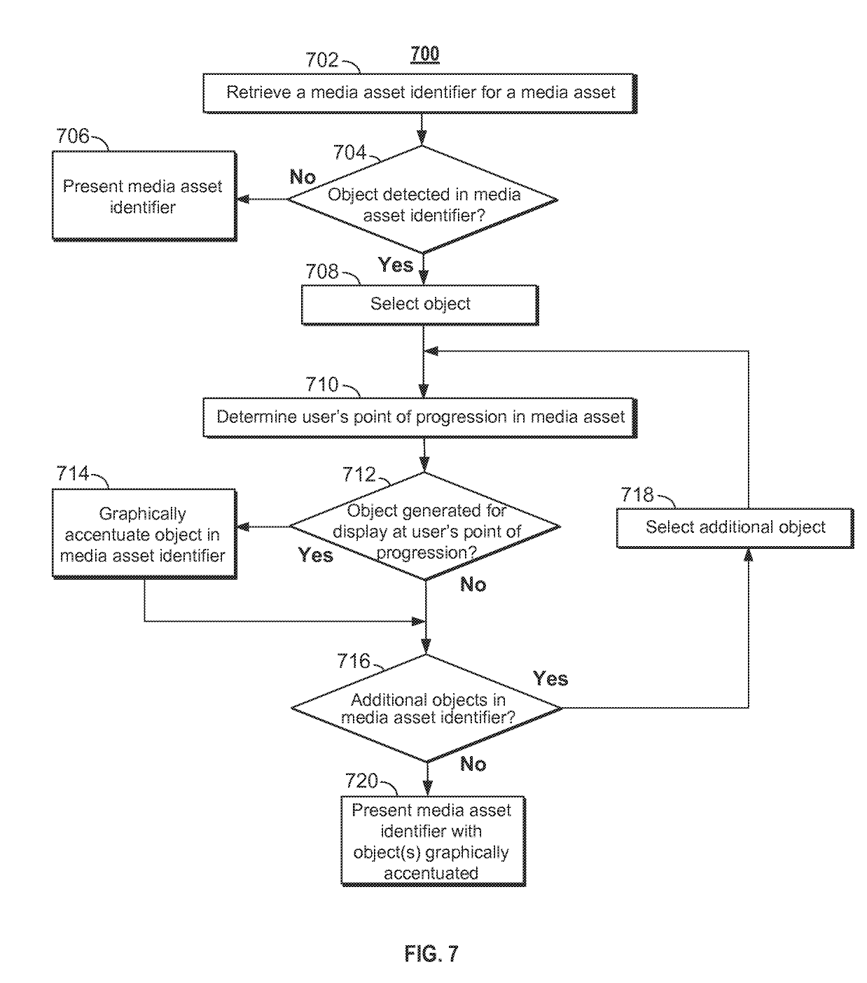

FIG. 7 is a flowchart of illustrative steps for presenting a modified media asset identifier based on whether or not an object or objects detected in the media asset identifier has been generated for display at the user's point of progression in accordance with some embodiments of the disclosure. It should be noted that process 700 or any step thereof could be performed on, or provided by, any of the devices shown in FIGS. 3-4. For example, process 700 may be executed by control circuitry 304 (FIG. 3) as instructed by a media guidance application implemented on user equipment 402, 404, and/or 406 (FIG. 4) in order to generate for display clusters based on a ranking. In addition, one or more steps of process 700 may be incorporated into or combined with one or more steps of any other process or embodiment.

At step 702, control circuitry 304 may retrieve a media asset identifier for a media asset, in accordance with some embodiments of the disclosure. The media asset identifier, for example, may be retrieved from storage 308, accessed via communications network 414, or accessed via any other suitable means, or any combination thereof. The media asset identifier may be retrieved responsive to a user request for a mosaic display including a plurality of media asset identifiers. In another example, the media asset identifier may be retrieved when the user pauses a media asset or accesses a menu showing paused media assets.

At step 704, control circuitry 304 may determine if an object is detected in the media asset identifier, in accordance with some embodiments of the disclosure. Objects may be detected using a content recognition module that may use object recognition techniques to process a given frame from a media asset including but not limited to edge detection, pattern recognition, optical character recognition, and/or any other suitable technique or method to determine objects in the media asset. Objects may also detected by processing metadata, closed captioning, or other information associated with the media asset but not necessarily visible to the user. For example, in second media asset identifier 550 (FIG. 5), control circuitry 304 has detected accentuated object 552. If no object has been detected, the media asset identifier is presented, at step 706, using display 312. For example, the retrieved media asset identifier may be an abstract representation of the media asset and contain no detectable objects. In such a case, the media asset identifier would be presented without being processed at the subsequent steps.

If an object is detected at step 704, control circuitry 304 proceeds to select the object in the media asset identifier at step 708. This may be done by temporarily storing an association between the detected object and the retrieved media asset identifier at storage 308 or by updating a database listing objects in media asset identifiers such as the database used in step 606 of FIG. 6.

Control circuitry 304 then determines the user's point of progression in the media asset at step 710. For example, control circuitry 304 may determine the last frame generated for display to the user. This is shown in FIG. 5 as frame 500. In another example, control circuitry 304 may, using a provided metadata structure describing the scenes of a media asset, determine the current scene being presented to the user.

At step 712, control circuitry 304 may determine if the previously-detected object is generated for display at the user's point of progression. If the object is generated for display, control circuitry 304 may graphically accentuate the object in the media asset identifier at step 714. For example, object 502, corresponding to previously-detected accentuated object 552, has been generated for display in frame 500 (FIG. 5). As such, control circuitry 304 has modified the line thickness of accentuated object 552 relative to second media asset identifier 550. In another example, a border may be drawn around the object in the media asset identifier to make it more visible.

If there are additional objects present in the media asset identifier, as determined at step 716, an additional object is selected at step 718 and the process repeats from step 710. For example, a movie having an ensemble cast may have a poster (i.e., a media asset identifier) associated with it that shows likenesses of multiple actors and actresses. An example of such a poster can be seen in second media asset identifier 550 (FIG. 5). Each of those likenesses, having been detected as objects present in the media asset identifier (e.g., at step 704), may be processed in this manner. Other types of objects, such as actor name 554 and media asset title 556, may also be processed this way.

If there are no additional objects present in the media asset identifier, as determined at step 716, control circuitry 304 may, at step 720, present the media asset identifier with the identified objects graphically accentuated as previously discussed. For example, second media asset identifier 550 of FIG. 5 may be presented at this time. Control circuitry 304 may also populate a database listing objects in media asset identifiers for the media asset with each of the objects detected in each of the media asset identifiers for the media asset. The database may be provided by the provider of media content source 416 or media guidance data source 418 or by a third party. The database may also be stored locally at storage 308. Populating this database in this manner may reduce the amount of processing required when media asset identifiers are selected for the given media asset in the future.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 7.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for selecting identifiers for media assets, the method comprising:
determining a user's point of progression in a media asset;
identifying an object corresponding to the user's point of progression in the media asset;
cross-referencing a database listing objects in media asset identifiers for the media asset to select a media asset identifier from the media asset identifiers that includes the object; and
generating for display the selected media asset identifier.

2. The method of claim 1, further comprising:
retrieving the media asset identifiers for the media asset;
determining each of the objects in each of the media asset identifiers; and
populating the database with each of the objects in each of the media asset identifiers for the media asset.

3. The method of claim 1, wherein the selected media asset identifier comprises an image related to the media asset.

4. The method of claim 1, further comprising:
determining a location of the object within the selected media asset identifier; and
graphically accentuating the object in the selected media asset identifier.

5. The method of claim 4, wherein graphically accentuating the object comprises altering an opaqueness level of the object relative to the selected media asset identifier.

6. The method of claim 4, wherein graphically accentuating the object comprises altering a brightness level of the object relative to the selected media asset identifier.

7. The method of claim 1, wherein the user's point of progression identifies a current scene within the media asset or a current frame within the media asset, and wherein identifying the object corresponding to the user's point of progression in the media asset comprises identifying the object in the current scene or the current frame.

8. The method of claim 1, wherein the object is a character in the media asset.

9. The method of claim 1, further comprising selecting a default media asset identifier if the object is not found in the database.

10. The method of claim 1, further comprising:
identifying a plurality of objects corresponding to the user's point of progression in the media asset; and
selecting objects to be cross-referenced from among the plurality of objects.

11. A system for selecting identifiers for media assets, the system comprising:
storage circuitry configured to store a database listing objects in media asset identifiers for a media asset; and
control circuitry configured to:
determine a user's point of progression in the media asset;
identify an object corresponding to the user's point of progression in the media asset;
cross-reference the database listing the objects in media asset identifiers for the media asset to select a media asset identifier that includes the object; and
generate for display the selected media asset identifier.

12. The system of claim 11, wherein the control circuitry is further configured to:
retrieve the media asset identifiers for the media asset;
determine each of the objects in each of the media asset identifiers; and
populate the database with each of the objects in each of the media asset identifiers for the media asset.

13. The system of claim 11, wherein the selected media asset identifier comprises an image related to the media asset.

14. The system of claim 11, wherein the control circuitry is further configured to:
determine a location of the object within the selected media asset identifier; and
graphically accentuate the object in the selected media asset identifier.

15. The system of claim 14, wherein the control circuitry is further configured to graphically accentuate the object by altering an opaqueness level of the object relative to the selected media asset identifier.

16. The system of claim 14, wherein control circuitry is further configured to graphically accentuate the object by altering a brightness level of the object relative to the selected media asset identifier.

17. The system of claim 11, wherein the user's point of progression identifies a current scene within the media asset or a current frame within the media asset, and wherein the control circuitry configured to identify the object corresponding to the user's point of progression in the media asset is further configured to identify the object in the current scene or the current frame.

18. The system of claim 11, wherein the object is a character in the media asset.

19. The system of claim 11, wherein the control circuitry is further configured to select a default media asset identifier if the object is not found in the database.

20. The system of claim 11, wherein the control circuitry is further configured to:
identify a plurality of objects corresponding to the user's point of progression in the media asset;
select objects to be cross-referenced from among the plurality of objects.

21-50. (canceled)
